(19) United States
(12) Patent Application Publication
(10) Pub. No.: US 2009/0037208 A1
(43) Pub. Date: Feb. 5, 2009

(54) Using a reason code to indicate a reason for a rating of a network interaction

(75) Inventors: Gary J. Sullivan, San Francisco, CA (US); Jim Pitkow, San Francisco, CA (US); Marc Brown, Palo Alto, CA (US); Derek Walters, Goleta, CA (US); Marco Pinter, Santa Barbara, CA (US); Jonathan Southard, Santa Barbara, CA (US); Charles S. Jordan, Santa Barbara, CA (US)

Correspondence Address: VAN PELT, YI & JAMES LLP, 10050 N. FOOTHILL BLVD #200, CUPERTINO, CA, 95014, US

(73) Assignee: Fraudwall Technologies, Inc.

(21) Appl. No.: 11/890,312

(22) Filed: Aug. 3, 2007

(51) Int. Cl. G06Q 99/00

(52) U.S. Cl. 705/1

(57) ABSTRACT

Providing a reason code for a network interaction is disclosed. One or more data regarding a new incoming network interaction originated from a third party device over a network is received. A rating of the network interaction is determined based at least in part on the one or more data regarding the network interaction. A reason code is determined. The reason code indicates a reason for the rating. The reason code for the network interaction is provided.

### BACKGROUND OF THE INVENTION

Revenue for Internet companies is often driven by advertising, which is typically paid out based on a network interaction (e.g., a click) on an advertisement. However, sometimes a network interaction is not legitimate—for example, a botnet may be developed to cause network interactions on an advertisement. Illegitimate network interactions lead to inappropriate payments by advertisers and inappropriate payments to publishers. Advertisers and publishers need to be informed of legitimate and illegitimate network interactions in order to determine appropriate payments. However, the information provided may release information that helps illegitimate network interaction creators to mask their activity.

### BRIEF DESCRIPTION OF THE DRAWINGS

Various embodiments of the invention are disclosed in the following detailed description and the accompanying drawings.

FIG. 1 is a block diagram illustrating an embodiment of a system for rating a network interaction.

FIG. 2 is a flow diagram illustrating an embodiment of a process for rating a network interaction.

FIG. 3 is a flow diagram illustrating an embodiment of a process for receiving a data regarding a network interaction.

FIG. 4 is a flow diagram illustrating an embodiment of a process for determining a rating based on data.

FIG. 5 is a flow diagram illustrating an embodiment of a process for determining a reason code.

FIG. 6 is a block diagram illustrating an embodiment of providing a rating and reason code.

FIG. 7 is a block diagram illustrating an embodiment of providing a reason code.

FIG. 8 is a block diagram illustrating an embodiment of providing a reason code.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Providing a rating and/or a reason code for a network interaction is disclosed. A rating is provided to an advertiser and/or a publisher so that an understanding can be determined of a payment between the advertiser and the publisher. However, the advertiser and/or publisher may desire more knowledge regarding one or more network interactions and why the rating was determined as it was. On the other hand, if too much information is provided as to why the rating was determined as it was, then it may be possible to fool the rating system. A reason code is provided to provide a reason for the rating of a network interaction. The reason code provides some information to the advertiser and/or publisher without indicating the exact nature of which information affects a rating or how that information affects a rating. This provides evidence that the rating is legitimate to the advertiser and/or publisher while still protecting the specifics of the rating system against would-be fraud of the rating system.

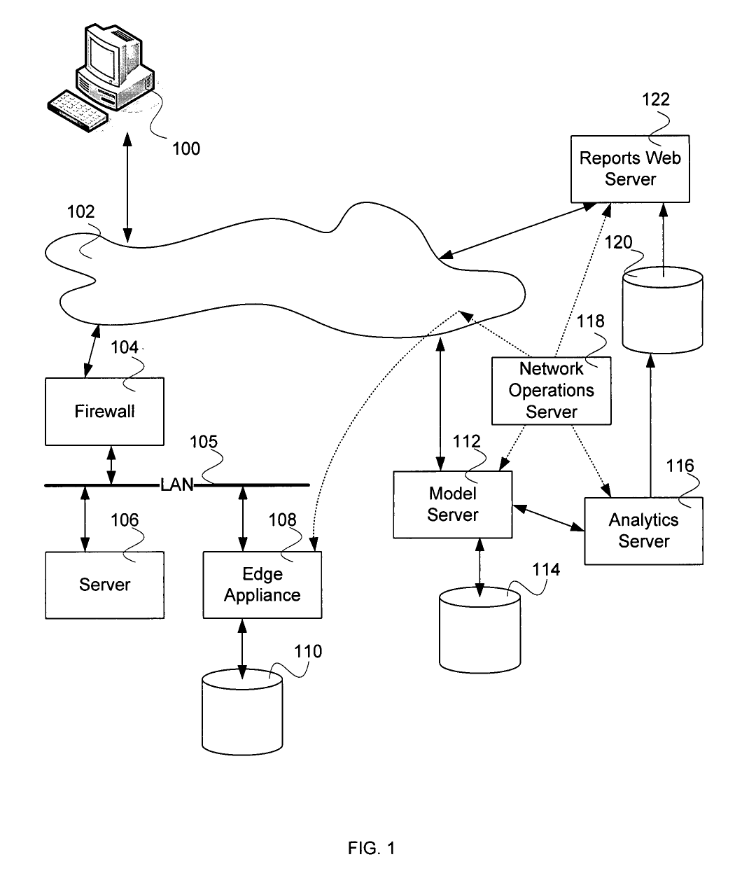

FIG. 1 is a block diagram illustrating an embodiment of a system for rating a network interaction. In the example shown, computer 100 is used by a user for accessing a web page on server 106. In various embodiments, server 106 is associated with an advertising network or an advertiser. Computer 100 is able to communicate with network 102. In various embodiments, network 102 comprises one or more of the following: the Internet, a local area network, a wide area network, a wired network, a wireless network, or any other appropriate network. Server 106 can be accessed from network 102 via firewall 104 and local area network (LAN) 105. Edge appliance 108 is able to monitor traffic to and from server 106 and is connected to LAN 105. In various embodiments, monitoring comprises detecting in hardware the network traffic or the network interactions to be monitored, detecting in real-time network traffic, capturing data in real-time, analyzing data in real-time, triggering real-time queries or forensics of Internet protocol (IP) addresses/network topology/routing tables/preferred paths, detecting layer 3 through layer 7 data from the monitored traffic, monitoring Ethernet traffic, or any other appropriate monitoring of network traffic. Edge appliance 108 is able to store information on storage device 110. In some embodiments, edge appliance 108 monitors traffic to and from server 106 by being between server 106 and LAN 105 by receiving and forwarding all traffic between network 102 and server 106. In this situation, all traffic is received and forwarded without substantially affecting network traffic, without substantially affecting a transaction involving the network traffic, and/or with little delay (e.g., less than 2 milliseconds of delay) for the process of receiving and forwarding to make it appear as if the device is essentially not present.

In some embodiments, edge appliances can also be used to monitor traffic at other points in the network other than in front of or just beside a server - for example, on a trunk line, an internet service provider network, an advertising network, or any other appropriate traffic site.

In some embodiments, server 106 reports information regarding the network interaction. For example, a software monitor records information regarding a network interaction including a time, an IP originating address, a domain, a country, an operating system, user agent, referrer, stem portion of referrer (“referrer-stem”, query portion of referrer (“referrer-query”), referrer query length, search key word, search key word frequency, etc. The software monitor forwards the information regarding the network interaction to model server 112 or analytics server 116 as appropriate to enable the use of the information to rate the network interaction. In some embodiments, where server 106 reports information regarding the network interaction, edge appliance 108 is not present.

Edge appliance 108 is able to communicate with model server 112. Edge appliance 108 periodically transmits reports and receives models from model server 112. Model server 112 can store information on storage device 114. Model server 112 forwards reports from edge appliance 108 to analytics server 116 and forwards models from analytics server 116 to edge appliance 108. In some embodiments, there are a plurality of model servers and a plurality of edge appliances, where an analytics server is able to support the communications with a plurality of model servers, and a model server is able to support the communications with a plurality of edge appliances. In some embodiments, scalability is achieved using a plurality of model servers.

Models are used by edge appliance 108 to calculate a preliminary score in real-time or quasi-real-time for detected network interactions. A preliminary score can be based on information associated with detected network interaction(s) as well as on stored parameters or models received from a model server or an analytics server such as model server 112 and analytics server 116, respectively.

Analytics server 116 stores report information to storage device 120 which acts as a data warehouse for the report information. Reports web server 122 can build reports based on the data stored in storage device 120. Network operations server 118 monitors the health and status of the system for analyzing network interactions including model server 112, analytics server 116, reports web server 122, and edge appliance 108. Network operations server 118 is able to communicate with each of the system hardware units including model server 112, analytics server 116, reports web server 122, and edge appliance 108 (in some cases directly or via the Internet with edge appliance 108 and in some cases via the Internet, through firewall 104, and via LAN 105).

In various embodiments, edge appliance 108 monitors network traffic on a local network that is separated from other networks (e.g., the Internet) by a firewall, receives network traffic from a local network and transmits the network traffic to a web server, receives network traffic from a local network that also transmits the network traffic to a web server, or receives network traffic from any other point or between any other two points appropriate for monitoring network traffic.

In various embodiments, model server 112, analytics server 116, network operations server 118, and reports web server 122 are implemented in separate servers or computer hardware units, in a single server or computer hardware unit, or any combination of separate and combined servers or computer hardware units.

In various embodiments, different combinations of model server 112, analytics server 116, and reports web server 122 are used to determine a rating and/or a reason code for a network interaction.

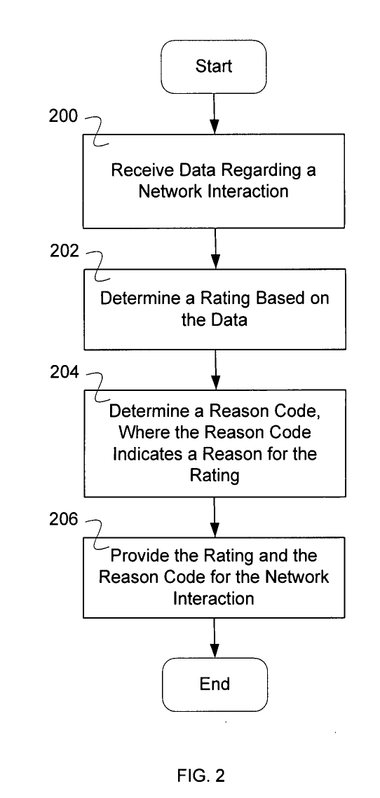

FIG. 2 is a flow diagram illustrating an embodiment of a process for rating a network interaction. In the example shown, in 200 a data is received regarding a network interaction. In 202, a rating is determined based on the data. In 204, a reason code is determined, where the reason code indicates a reason for the rating. In 206, the rating and the reason code are provided for the network interaction.

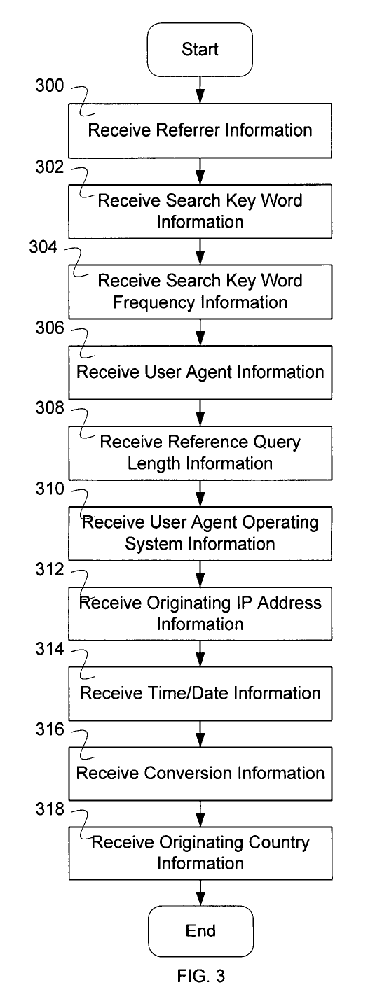

FIG. 3 is a flow diagram illustrating an embodiment of a process for receiving a data regarding a network interaction. In some embodiments, the process of FIG. 3 is used to implement 200 of FIG. 2. In the example shown, in 300 referrer information is received. In 302, search key word information is received. In 304, search key word frequency information is received. In 306, user agent information is received. In 308, referrer-query length information is received. In 310, user agent operating system information is received. In 312, originating IP address information is received. In 314, time and/or date information is received. In 316, conversion information is received. In 318, originating country information is received.

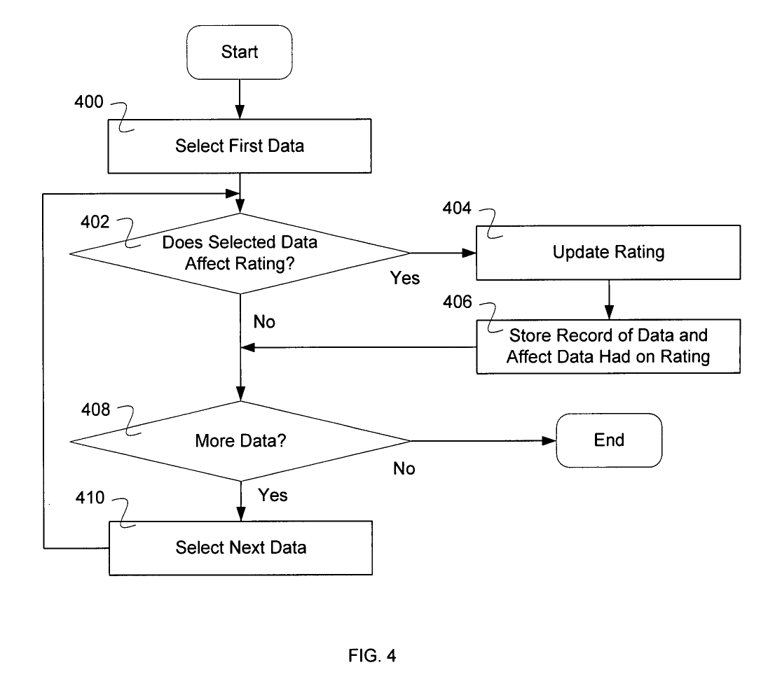

FIG. 4 is a flow diagram illustrating an embodiment of a process for determining a rating based on data. In some embodiments, the process of FIG. 4 is used to implement 202 of FIG. 2. In the example shown, in 400 a first data is selected. In 402, it is determined if the selected data affects the rating. If the selected data affects the rating, then in 404, the rating is updated. In some embodiments, prior data is considered when updating a rating. For example, previous network interactions and the data regarding timing, sources, routes, countries, domains, IP addresses, conversions, etc. can influence the rating update. In 406, a record of the data and the affect the data had on the rating is stored, and control passes to 408. If the selected data does not affect the rating, control passes to 408. In 408, it is determined if there is more data. If there is more data, then in 410 a next data is selected, and control passes to 402. If there is no more data, then the process ends. In various embodiments, the rating is summarized as a positive rating (e.g., ‘+’ or graded positive rating ‘++’), a neutral rating, a negative rating (e.g., ‘−’ or a graded negative rating ‘−−−’), a fraudulent rating, a conversion rating (e.g., likely to convert), a letter rating (e.g., A, B, AA, B+, etc.), a number ranking (e.g., 1, 2, etc.), or any other appropriate rating.

In some embodiments, data received regarding a network interaction indicates that the network interaction is one of many recent visits from the same IP address, the rating process rates the network interaction such that the rating would decrease, whereas data received regarding a network interaction that indicates that the network interaction is one of many recent visits from the same IP address during which conversions and/or purchases have been made, the rating for the network interaction would increase. In this example, the rating system has ratings that increase for a better/desirable network interaction and decrease for worse/undesirable network interactions.

In various embodiments, a rating calculation is based on empirical and/or statistical models of network interactions and outcomes (i.e., conversions and/or purchases). In various embodiments, a rating calculation is based on a series of business rules which in turn rely on statistical models, do not rely of statistical models, rely on empirical models, or any other appropriate basis for ratings.

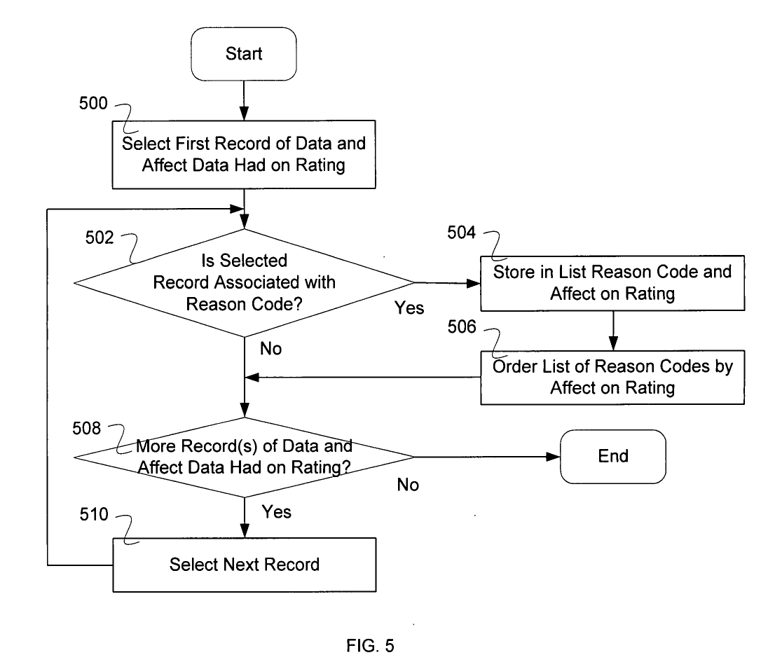

FIG. 5 is a flow diagram illustrating an embodiment of a process for determining a reason code. In some embodiments, the process of FIG. 5 is used to implement 204 of FIG. 2. In the example shown, in 500 a first record is selected of data and the affect the data had on the rating. In 502, it is determined if the selected record is associated with a reason code. If the record is associated with a reason code, then in 504 the reason code and affect on the rating is stored in a list. In some embodiments, multiple records (and hence multiple data) are associated with a given reason code. In 506, the list of reason codes is ordered by affect on the rating, and control passes to 508. If the record is not associated with a reason code, then control passes to 508. In 508, it is determined if there are more records of data and the affect the data had on the rating. If there is/are more record(s), then in 510 a next record is selected, and control passes to 502. If there are no more records, then the process ends.

In some embodiments, the list is sorted after processing all records. In some embodiments, the list is not sorted.

In some embodiments, a reason code list changes over time to reflect new information appropriate for positive or negative affects on ratings.

In various embodiments, a reason code comprises one of the following items: self-identified robot, crawler, spider; repeat adclick; double click on ad; blank referrer; referred from major search engine; not referred from major search engine; rare search term; user_agent not Mozilla; referrer-query not provided; referrer-query too long; unusual operating system; no visits from this IP in last 24 hours; never seen this IP before; visits have too few page requests from this IP recently; visits too brief from this IP recently; recent visits from this IP; using rare HTTP protocol; never seen this domain before; too many adclicks from this domain recently; previous requests too recent from this IP; blank user agent; lack of recent conversions from this IP; too few recent conversions from this IP; rare browser; lack of recent visits from this country; lack of recent conversions from this country; too few recent conversions from this country; Canadian adclick; Foreign adclick; too many recent adclicks for this IP; IP Forensics; or any other appropriate reason code.

In some embodiments, a reason code is provided using a numeric or alphanumeric code. For example, a self-identified robot, a self-identified crawler, or a self-identified spider is provided by providing a single numeric code (e.g., ‘2’).

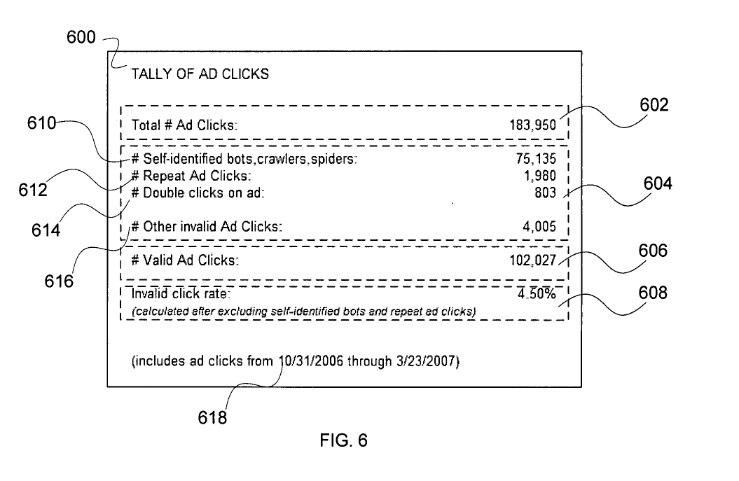

FIG. 6 is a block diagram illustrating an embodiment of providing a rating and reason code. In some embodiments, FIG. 6 is provided on execution of 206 of FIG. 2. In the example shown, a tally of ad clicks 600 includes a reporting of total number of ad clicks 602, invalid ad clicks 604, valid ad clicks 606, and ad click statistic 608. Total number of ad clicks 602 reports the total number of network interactions with respect to an advertisement during the period of time 618. A rating of invalid for clicks is provided by invalid ad clicks 604. Invalid ad clicks 604 reports network interactions with respect to an advertisement during period of time 618. For example, reason code 610 (i.e., self-identified robot, crawler, spider), reason code 612 (i.e., repeat ad clicks), and reason code 614 (i.e., double clicks on ad). Other reason codes are aggregated into a single reason code in this report 616 titled ‘Other Invalid Ad Clicks’. A rating of valid for clicks is provided by valid ad clicks 606. Click statistic 608 which provides a calculated statistic based on the findings regarding network interactions.

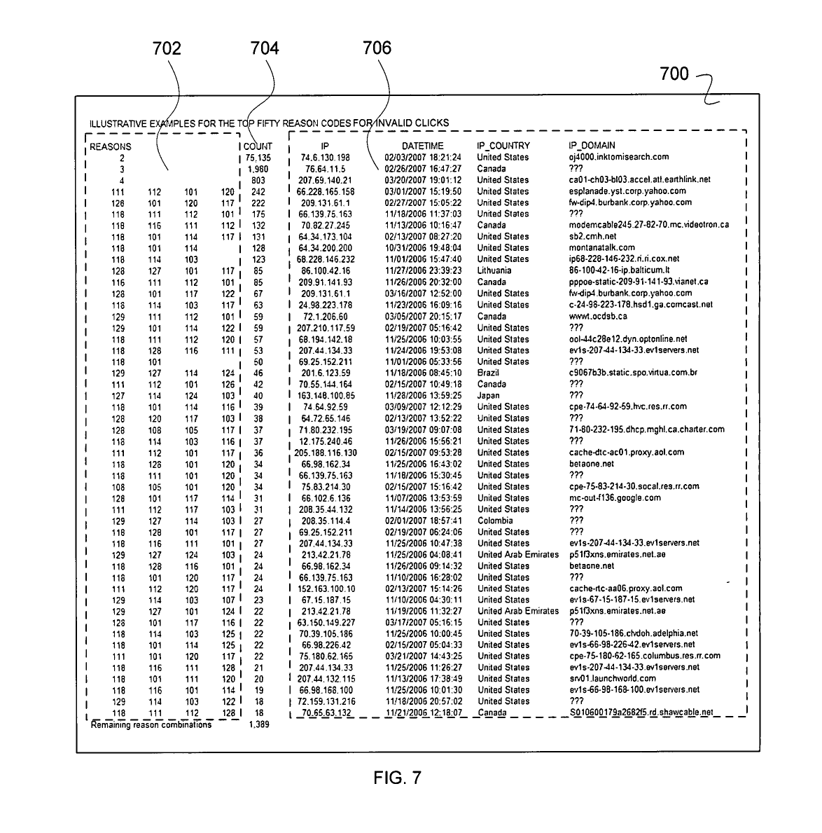

FIG. 7 is a block diagram illustrating an embodiment of providing a reason code. In some embodiments, FIG. 7 is provided on execution of 206 of FIG. 2. In the example shown, illustrative examples of the fifty top reason codes for invalid clicks 700 includes ordered list of reason codes 702, count 704, and illustrative example 706. Ordered list of reason codes 702 includes a list of up to four reason codes for an invalid rating of a network interaction. The reason codes are ordered in such a way that the left most reason code had the most affect on the rating, and proceeding to the right the reason codes had less and less affect on the rating. In some cases there are not four codes that contributed to the rating, and in these cases there are blank spaces in the ordered list of reason codes 702. Count 702 indicates the number of network interactions associated with the reason code list to its left as relevant reason code combinations used for rating the network interaction. Illustrative example 706 provides information for one example of a network interaction with the reason code combination. Illustrative example 706 provides an originating IP address of the network interaction, a date/time, a country of origin, and an IP domain name.

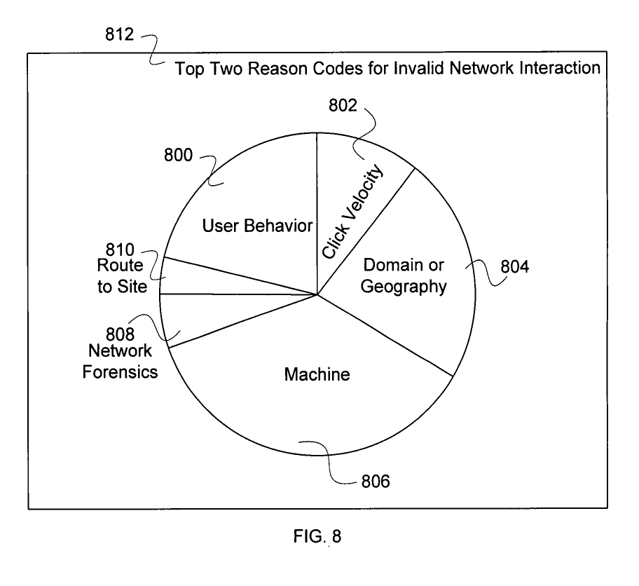

FIG. 8 is a block diagram illustrating an embodiment of providing a reason code. In some embodiments, FIG. 8 is provided on execution of 206 of FIG. 2. In the example shown, top two reason codes for an invalid network interaction 812 shows a pie chart illustrating the percentage occurrence of a reason code or group of reason codes being in the top two reason codes. The pie chart includes reason codes or reason code groups user behavior 800, click velocity 802, domain or geography 804, machine 806, network forensics 808, and route to site 810. User behavior 800 includes reason codes such as recent visits from this IP; visits too brief from this IP recently; visits have too few page requests from this IP recently; too few recent conversions from this IP; and lack of recent conversions from this IP. Click velocity 802 includes reason codes such as too many recent adclicks for this IP and previous requests too recent from this IP. Domain or geography 804 includes reason codes such as too few recent conversions from this country; lack of recent conversions from this country; lack of recent visits from this country; too many adclicks from this domain recently; never seen this domain before; Foreign adclick; and Canadian adclick. Machine 806 includes reason codes such as referrer-query too long; blank user agent; referrer-query not provided; blank referrer; rare browser; using rare HTTP protocol; unusual operating system; and user_agent not Mozilla. Network forensics 808 includes reason codes such as IP Forensics. Route site 810 includes reason codes such as rare search term; not referred from major search engine; and referred from major search engine.

In some embodiments, reason code groups change over time as new reason codes are added and removed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of providing a reason code for a network interaction comprising:
receiving one or more data regarding a new incoming network interaction originated from a third party device over a network;
determining a rating of the network interaction based at least in part on the one or more data regarding the network interaction;
determining a reason code, wherein the reason code indicates a reason for the rating; and
providing the reason code for the network interaction.

2. A method as in claim 1, further comprising providing the rating for the network interaction.

3. A method as in claim 1, wherein the one or more data comprises a referrer for the network interaction.

4. A method as in claim 1, wherein the one or more data comprises a search key word for the network interaction.

5. A method as in claim 1, wherein the one or more data comprises a search key word frequency for the network interaction.

6. A method as in claim 1, wherein the one or more data comprises a user agent for the network interaction.

7. A method as in claim 1, wherein the one or more data comprises a reference query length for the network interaction.

8. A method as in claim 1, wherein the one or more data comprises a user agent operating system for the network interaction.

9. A method as in claim 1, wherein the one or more data comprises an IP originating address for the network interaction.

10. A method as in claim 1, wherein the one or more data comprises a time for the network interaction.

11. A method as in claim 1, wherein the one or more data comprises a conversion data for the network interaction.

12. A method as in claim 1, wherein the one or more data comprises an originating country for the network interaction.

13. A method as in claim 1, wherein the network interaction comprises a click.

14. A method as in claim 1, wherein the network interaction is one of a plurality of network interactions.

15. A method as in claim 1, wherein the rating comprises positive rating.

16. A method as in claim 1, wherein the rating comprises neutral rating.

17. A method as in claim 1, wherein the rating comprises negative rating.

18. A method as in claim 1, wherein the rating comprises fraudulent rating.

19. A method as in claim 1, wherein the rating comprises conversion rating.

20. A method as in claim 1, wherein the rating comprises quality rating.

21. A method as in claim 1, wherein the reason code is provided using a numeric or alphanumeric code.

22. A method as in claim 1, wherein the reason code is one of a plurality of reason codes.

23. A method as in claim 22, wherein the plurality of reason codes comprises an ordered list of the plurality of reason codes influencing the rating.

24. A method as in claim 1, wherein the reason code comprises self-identified robot.

25. A method as in claim 1, wherein the reason code comprises self-identified crawler.

26. A method as in claim 1, wherein the reason code comprises self-identified spider.

27. A method as in claim 1, wherein the reason code comprises repeat adclick.

28. A method as in claim 1, wherein the reason code comprises double click on ad.

29. A method as in claim 1, wherein the reason code comprises blank referrer.

30. A method as in claim 1, wherein the reason code comprises referred from major search engine.

31. A method as in claim 1, wherein the reason code comprises not referred from major search engine.

32. A method as in claim 1, wherein the reason code comprises rare search term.

33. A method as in claim 1, wherein the reason code comprises user_agent not Mozilla.

34. A method as in claim 1, wherein the reason code comprises referrer-query not provided.

35. A method as in claim 1, wherein the reason code comprises referrer-query too long.

36. A method as in claim 1, wherein the reason code comprises unusual operating system.

37. A method as in claim 1, wherein the reason code comprises no visits from this IP in last 24 hours.

38. A method as in claim 1, wherein the reason code comprises never seen this IP before.

39. A method as in claim 1, wherein the reason code comprises visits have too few page requests from this IP recently.

40. A method as in claim 1, wherein the reason code comprises visits too brief from this IP recently.

41. A method as in claim 1, wherein the reason code comprises recent visits from this IP.

42. A method as in claim 1, wherein the reason code comprises using rare HTTP protocol.

43. A method as in claim 1, wherein the reason code comprises never seen this domain before.

44. A method as in claim 1, wherein the reason code comprises too many adclicks from this domain recently.

45. A method as in claim 1, wherein the reason code comprises previous requests too recent from this IP.

46. A method as in claim 1, wherein the reason code comprises blank user agent.

47. A method as in claim 1, wherein the reason code comprises lack of recent conversions from this IP.

48. A method as in claim 1, wherein the reason code comprises too few recent conversions from this IP.

49. A method as in claim 1, wherein the reason code comprises rare browser.

50. A method as in claim 1, wherein the reason code comprises lack of recent visits from this country.

51. A method as in claim 1, wherein the reason code comprises lock of recent conversions from this country.

52. A method as in claim 1, wherein the reason code comprises too few recent visits from this country.

53. A method as in claim 1, wherein the reason code comprises Canadian adclick.

54. A method as in claim 1, wherein the reason code comprises foreign adclick.

55. A method as in claim 1, wherein the reason code comprises too many recent adclicks for this IP.

56. A method as in claim 1, wherein the reason code comprises IP Forensics.

57. A computer program product for rating a network interaction, the computer program product being embodied in a computer readable medium and comprising computer instructions for:
receiving one or more data regarding a new incoming network interaction originated from a third party device over a network;
determining a rating of the network interaction based at least in part on the one or more data regarding the network interaction;
determining a reason code, wherein the reason code indicates a reason for the rating; and
providing the rating and the reason code for a network interaction.

58. A system for rating a network interaction comprising:
a processor; and
a memory coupled with the processor, wherein the memory is configured to provide the processor with instructions which when executed cause the processor to:
receive one or more data regarding a new incoming network interaction originated from a third party device over a network;
determine a rating of the network interaction based at least in part on the one or more data regarding the network interaction;
determine a reason code, wherein the reason code indicates a reason for the rating; and
provide the rating and the reason code for a network interaction.
